(19) United States
(12) Patent Application Publication
(10) Pub. No.: US 2006/0159858 A1
(43) Pub. Date: Jul. 20, 2006

(54) Coating process

(75) Inventors: Elisabeth Danger, Paderborn (DE); Martin Pohl, Bielefeld (DE)

Correspondence Address: Henry M. Feiereisen;Henry M. Feiereisen, LLC, Suite 4714, 350 Fifth Avenue, New York, NY, 10118, US

(73) Assignee: Benteler Automobiltechnik GmbH, Paderborn (DE)

(21) Appl. No.: 11/330,456

(22) Filed: Jan. 12, 2006

(30) Foreign Application Priority Data
Jan. 19, 2005 (DE) 10 2005 002 706.7

(51) Int. Cl. B05D 1/04; B05D 1/12; B05D 3/02; B05D 3/00

(52) U.S. Cl. 427/458; 427/180; 427/374.1; 427/299

(57) ABSTRACT

In a method of applying a firmly adhering metallic coating onto a profiled structure of steel sheet, a profiled structure of steel sheet is fogged in with metal powder in a treatment chamber. The metal powder is deposited electrostatically across the surface of the profiled structure. The profiled structure is then subjected to a heat treatment for realizing a coating as a consequence of a diffusion process between the steel sheet and the metal powder. Subsequently, the profiled structure is cooled down.

### CROSS-REFERENCES TO RELATED APPLICATIONS

This application claims the priority of German Patent Application, Serial No. 10 2005 002 706.7, filed Jan. 19, 2005, pursuant to 35 U.S.C. 119(a)-(d), the content of which is incorporated herein by reference.

### BACKGROUND OF THE INVENTION

The present invention relates, in general, to a method of applying a metallic coating onto a profiled structure of steel sheet.

Certain properties, such as corrodibility or wear-resistance, of a profiled structure of steel sheet can be improved through application of a coating. Various coating processes are known that result in application of an adhering coating of amorphous substances upon metallic surfaces. Examples include hot-dip galvanizing, thermal spraying of zinc, flame spraying, high-speed flame spraying, arc spraying or plasma spraying, sherardizing, and electrogalvanizing. These conventional processes are, however, inadequate to produce a high-quality coating on a large scale, as demanded in the automobile industry.

It would therefore be desirable and advantageous to provide an improved coating process to firmly apply a metallic coating onto a profiled structure of sheet steel, which process obviates prior art shortcomings and allows large scale production for use in the automobile industry while enhancing the properties of the profiled structure especially as far as a protection against corrosion is concerned.

### SUMMARY OF THE INVENTION

According to one aspect of the present invention, a method of applying a metallic coating onto a profiled structure of steel sheet includes the steps of fogging a profiled structure of steel sheet with metal powder in a treatment chamber, allowing the metal powder to deposit electrostatically across the surface of the profiled structure, subjecting the profiled structure to a heat treatment for realizing a coating as a consequence of a diffusion process between the steel sheet and the metal powder, and cooling the profiled structure.

During heat treatment, a coating thus forms on the surface of the profiled structure, which has been fogged in beforehand, metallically pure, in the treatment chamber, whereby the coating firmly adheres in view of the material union between the iron of the steel sheet and the metal powder. Suitably, the profiled structure of steel sheet is zinc coated or galvanized. In other words, a metal powder is used that contains as main ingredient zinc or zinc oxide. Optionally, additives may be added to improve chemical and physical properties of the coating. During heat treatment of the profiled structure, covered with zinc powder, diffusion processes between the base metal and the coating metal result in the formation of iron-zinc alloy layers. The coating is even and ductile.

According to another feature of the present invention, the profiled structure is subjected to a surface treatment before entering the treatment chamber and thus before application of a coating. As a result, the surface of the profiled structure is cleansed, rendering it bright and polished. An example of a suitable surface treatment step includes etching or sand blasting.

According to another feature of the present invention, the metal powder may be applied electrically or electrostatically. Currently preferred is an electric charging of the metal powder in the treatment chamber whereas the profiled structure is suspended, electrically grounded, in the treatment chamber. As a result of the differential in voltage, metal powder deposits evenly and across the entire surface of the profiled structure. As an alternative, it is certainly also conceivable to keep the metal powder uncharged while a high-voltage potential is applied across the profiled structure so that the profiled structure is charged electrically.

In addition to the charging potential, the thickness of the coating depends also on the temperature and treatment time. Therefore, according to another feature of the present invention, the heat treatment step may be executed at a temperature between 280° C. and 350° C., in particular between 300° C. and 320° C. Suitably, the heat treatment step is executed for a time period of 0.5 h to 4 h to allow formation of iron-zinc alloy layers at a thickness of up to 5-40 μm in the near surface area of the profiled structure.

According to another feature of the present invention, the heat treatment step may be subdivided into a heat-up phase and a retention phase for maintaining the treatment temperature over a certain time period. Suitably, the heating phase is executed for a time period of 0.5 to 2 h. In some cases, it is conceivable that the heat treatment is over after the heat-up phase so that the retention phase may last for a time period of 0 h to 2 h.

According to another feature of the present invention, the formation of the coating onto the profiled structure may be realized effectively in a continuous process. Suitably, a hot-formed profiled structure is coated immediately following the heat treatment with powdery zinc in a directly subsequent plant and advanced through a continuous furnace for carrying out the diffusion process. In this way, logistics and technical implementation can be simplified, resulting in cost-saving. Optionally, as stated above, a surface treatment may be carried out before the actual coating of the profiled structure.

According to another feature of the present invention, the cooling of the coated profiled structure should be executed evenly, suitably for a time period of up to a maximum of 1 h, to render the cooling phase efficiently.

The quality and property of the coating can be further adjusted by adding further components to the metal powder in addition to zinc or zinc oxide, to thereby affect the chemical behavior, especially as far as corrosion resistance is concerned, the physical behavior, especially as far as bonding strength of the coating is concerned, and the geometry of the coating and the layer thickness distribution.

The coating process according to the present invention results in the production of an even, high-quality coating, in particular zinc layer, on profiled structures of steel sheet. The application of the coating is realized in dry state while efficiently utilizing the coating material. Process-based losses in connection with the metal powder are minimized. The produced coating on the profiled structure is also, advantageously, capable to deform.

### BRIEF DESCRIPTION OF THE DRAWING

NONE

### DETAILED DESCRIPTION OF PREFERRED EMBODIMENTS

NONE

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A method of applying a metallic coating onto a profiled structure of steel sheet, comprising the steps of:
fogging a profiled structure of steel sheet with metal powder in a treatment chamber;
allowing the metal powder to deposit electrostatically across the surface of the profiled structure;
subjecting the profiled structure to a heat treatment for realizing a coating as a consequence of a diffusion process between the steel sheet and the metal powder; and
cooling the profiled structure.

2. The method of claim 1, wherein the metal powder includes zinc or zinc oxide.

3. The method of claim 1, wherein the metal powder is charged electrically in the treatment chamber.

4. The method of claim 3, wherein the profiled structure is suspended electrically grounded in the treatment chamber.

5. The method of claim 1, wherein the profiled structure is charged electrically in the treatment chamber.

6. The method of claim 1, wherein the metal powder is uncharged in the treatment chamber, whereas a high-voltage potential is applied across the profiled structure to electrically charge the profiled structure.

7. The method of claim 1, wherein the heat treatment step is executed at a temperature between 280° C. and 350° C.

8. The method of claim 1, wherein the heat treatment step is executed at a temperature between 300° C. and 320° C.

9. The method of claim 1, wherein the heat treatment step is executed for a time period of 0.5 h to 4 h.

10. The method of claim 2, wherein an iron-zinc alloy layer at a thickness of up to 5-40μm is formed on the surface of the profiled structure.

11. The method of claim 1, wherein the heat treatment step includes a heat-up phase and a retention phase, wherein the heat-up phase is executed for a time period of 0.5 to 2 h, and the retention phase is executed for a time period of 0 h to 2 h.

12. The method of claim 1, wherein the cooling step is executed for a time period of up to maximum of 1 h.

13. The method of claim 1, further comprising the step of subjecting the profiled structure to a surface treatment before entering the treatment chamber.

14. The method of claim 13, wherein the surface treatment is executed by a sand blasting process.

15. The method of claim 13, wherein the surface treatment is executed by a etching process.

16. The method of claim 1, wherein the formation of the coating upon the profiled structure is realized in a continuous process.
